(19) United States
(12) Patent Application Publication
(10) Pub. No.: US 2023/0213460 A1
(43) Pub. Date: Jul. 6, 2023

(54) SYSTEM AND A METHOD FOR DETERMINING THE NUMBER OF SMALL PRODUCT IN THE BAG PACKAGE FROM THE X-RAY IMAGE

(71) Applicant: ETI GIDA SANAYI VE TICARET ANONIM SIRKETI, Eskisehir (TR)

(72) Inventor: Mehmet UNLU, Eskisehir (TR)

(21) Appl. No.: 18/066,410

(22) Filed: Dec. 15, 2022

(30) Foreign Application Priority Data
Jan. 4, 2022 (TR) 2022/000080

(51) Int. Cl. G01N 23/04; G06T 5/20; G06V 10/75

(52) U.S. Cl. CPC G01N 23/04; G06T 5/20; G06V 10/751; G06T 2207/10116; G06T 2207/30242

(57) ABSTRACT

The present invention relates to a system for determining the number of small products in the bag package from the x-ray image that enables detecting the missing quantities of small products or packages in a disorganized and random position in the bag package.

### TECHNICAL FIELD OF THE INVENTION

The present invention relates to a system for determining the number of small products in the bag package from the x-ray image that enables detecting the missing quantities of small products or packages in a disorganized and random position in the bag package.

In particular, the present invention relates to the ability to sort the bag packages with missing numbers at the x-ray output by estimating the number of small packages in the bulk at random positions in three dimensions in the bag package.

### STATE OF THE ART

Today, conveyor systems that perform weighing in the product transition are used to provide the number of products inside the bag pack. The weighing process is performed as the product passes through the product transport conveyor working on the load cell called Loadcell. Depending on the fluctuation in weight of the product, missing pieces can be detected by this method.

In food production lines, there are methods developed to verify the in-pack quantity from the images obtained as the bag-packed products pass through the x-ray scanner. However, in the current x-ray image processing algorithms, the missing pieces of small products or packages that are disorganized and in random positions in the bag package cannot be detected.

The invention, which is the subject of the application numbered “JP2002214357A” in the state of the art, relates to an X-ray image inspection system and method capable of managing the quality of products according to numbers by which quality information about contamination with foreign matter and the number of contents is imparted to the products. A metal detector is used to check whether or not the products contain iron as a foreign matter. A weighing instrument measures the weight per one product. X-ray images of the products are taken and stored in an X-ray foreign matter inspection apparatus. A laser marker marks the package of the product by using a laser with a mark including data about the date of inspection or fabrication of the product.

The invention, which is the subject of the application numbered “JP2012242289A” in the state of the art, is a method for inspecting the number of products and package contents with high precision inspection in order to reduce the need for workers. Packaged products on the vertically moving band are inspected one by one by X-ray imaging, provided that they do not superimpose. In the image obtained after X-ray imaging, the number of products is determined by counting the protrusions and corners of the packaged product.

In the state of the art, there are systems that perform imaging for the package with X-ray and enable sorting the package in which the defective product is detected. In X-ray image processing algorithms, there is a need for a system that detects the missing pieces of small products or packages that are disorganized and in random positions in the bag package.

Consequently, the disadvantages disclosed above and the inadequacy of available solutions in this regard necessitated making an improvement in the relevant technical field.

### OBJECTS OF THE INVENTION

The present invention relates to a system for determining the number of small products in the bag package from the x-ray image that enables detecting the missing quantities of small products or packages in a disorganized and random position in the bag package.

The most important object of the present invention is to detect the missing quantities of small products or packages in disorganized and random positions.

Another object of the present invention is to enable the number of products to be determined by the contrast difference of the images.

Another object of the present invention is to ensure that the products that are found to be missing products are sorted out.

### DESCRIPTION OF THE FIGURES

FIG. 1 illustrates a view of schematic flow diagram of the system according to the present invention.

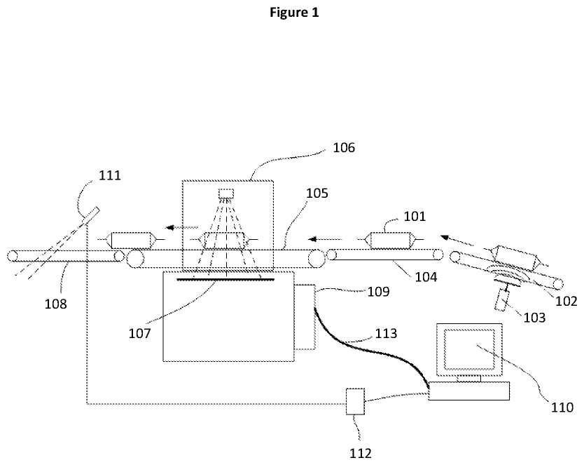

### REFERENCE NUMERALS

100. System for determining quantities of small products in the bag package from the X-ray image
101. Bag Package
102. Vibrating Band
103. Vibration Unit
104. Input Conveyor
105. Main Conveyor
106. X-ray Carrier
107. X-ray Detector
108. Output Conveyor
109. Control Unit
110. Image Processing Unit
111. Compressed Air Valve
112. Input-Output Card
113. Ethernet Connection

### DESCRIPTION OF THE INVENTION

The present invention relates to a system for determining the number of small products in the bag package from the x-ray image that enables detecting the missing quantities of small products or packages in a disorganized and random position in the bag package.

The system for determining quantities of small products in the bag package from the x-ray image (100) comprises bag package (101), vibrating band (102), vibration unit (103), input conveyor (104), main conveyor (105), x-ray carrier (106), x-ray detector (107), output conveyor (108), control unit (109), image processing unit (110), compressed air valve (111), and input-output card (112).

The bag package (101) contains the disorganized, free, and tangled products.

The vibrating band (102) prevents the products in the bag package (101) from clumping together with the vibration as it passes over the bag package (101), thereby making it more discrete and visually distinguishable.

The vibration unit (103) generates vibration on the vibrating band (102) and enables its amplitude and intensity to be adjusted.

The input conveyor (104) provides the transport of the bag package (101) coming from the vibrating band (102) to the main conveyor (105).

The main conveyor (105) carries the x-ray scanner (106) and x-ray detector (107) and the control unit (109) thereon, allowing the bag package (101) to be conveyed to the output conveyor (108).

The X-ray scanner (106) provides scanning of the products in the bag package (101) moving on the main conveyor (105).

The X-ray detector (107) creates the numerical data of the rays passing through the x-ray scanner (106) according to the energy level and provides creating a two-dimensional image.

The control unit (109) receives the two-dimensional images from the x-ray sensor (107) and ensures that they are saved to the computer therein. The control unit (109) provides the transfer of the images recorded to the image processing unit (110) via the ethernet connection (113).

The image processing unit (110) enables determining the parts of the product of interest in the package in the two-dimensional images receiving from the processor and the control unit (109), by filtering. The image processing unit (110) provides the filtering of parts with pixel value between 0 and 200 (adjusted) numerically by filtering. Thus, the product regions are detected. Upper and lower limit values of filter can be adjusted by the user. The image processing unit (110) determines the product groups and their limits that are not adjacent to each other from the filtered sections. The image processing unit (110) numerically calculates the grayness values for each group. The image processing unit (110) calculates the total grayness value by summing the grayness value in each pixel. The image processing unit (110) ensures that the moving average value of the total grayness values of each package is obtained, and this average value is divided by the number of in-pack units being worked at that time in order to obtain the average grayness value per product. The moving average number is a user changeable value. By means of the moving average, the mass change and indirectly the grayness change caused by the food processing differences of the product in the currently running process are changed in an adaptive manner, thereby resulting in more accurate results. The image processing unit (110) provides the estimation of how many products each group belongs to by dividing the calculated grayness value of each group by the average grayness per product unit value. Thus, the total number of items in the package is found. In another embodiment of the present invention, the image processing unit (110) provides the estimation of how many products there are by dividing the total grayness numerical value of the package by the unit product grayness value. The resulting product estimate value is a real number. The image processing unit (110) limits the sorting limit values of the package over real values.

The output conveyor (108) enables transporting the bag package (101) coming out of the main conveyor (105).

The input output card (112) provides the commands from the image processing unit (110) to be transmitted to the compressed air valve (111).

The compressed air valve (111) ensures that the defective ones from the bag packages (101) moving on the output conveyor (108) are sorted with the help of compressed air.

In an experimental study performed on an x-ray machine, 3-layer wafer slices covered with cream were scanned individually from x-ray. The measured gram mass values of each scanned product are different. This difference is due to differences in cream amount and other non-ideal processes. The pixel area value and the total grayness value were calculated by processing the image of each product and adapted to the table.

TABLE 1

| | | | | GRAY/ | AREA/ |
|---|---|---|---|---|---|
| | GRAM | AREA | GRAY | GRAM | GRAM |
| | 10.80 | 6403.00 | 553089.00 | 51211.94 | 592.87 |
| | 11.88 | 6693.00 | 601228.00 | 50608.42 | 563.38 |
| | 8.08 | 5985.00 | 406893.00 | 50358.04 | 740.72 |
| | 10.23 | 6216.00 | 519594.00 | 50791.20 | 607.62 |
| | 9.75 | 6224.00 | 497825.00 | 51058.97 | 638.36 |
| AVARAGE | 10.15 | 6304.20 | 515725.80 | 50805.72 | 628.59 |
| STANDARD | 1.40 | 263.17 | 72261.01 | 342.31 | 68.26 |
| DEVIATION | | | | | |
| PERCENTAGE- | 13.82 | 4.17 | 14.01 | 0.67 | 10.86 |
| STANDARD | | | | | |
| DEVIATION | | | | | |

In Table 1, the gray area area value (AREA), total grayness value (GRAY) and weight (GRAM) values for each product obtained from the grayscale image are given. And also (GRAY/GRAM) and (AREA/GRAM) values are also derived for analysis. With the examination, the lowest deviation value from these values is the GRAY/GRAM value. This shows that the data that is compatible with the weight (GRAM) value of the products is the total value of grayness (GRAY).

The data obtained from performing the same experiment with different products were shown in Table 2. Here, as a result, it is observed that the sum of the gray values in the sections of the product in the images obtained from x-ray gives proportional data with the total mass.

TABLE 2

| | | | | GRAY/ | AREA/ |
|---|---|---|---|---|---|
| | GRAM | AREA | GRAY | GRAM | GRAM |
| | 10.22 | 6237.00 | 521993.00 | 51075.64 | 610.27 |
| | 10.38 | 6443.00 | 530165.00 | 51075.63 | 620.71 |
| | 10.46 | 6354.00 | 535153.00 | 51161.85 | 607.46 |
| | 10.71 | 6437.00 | 547260.00 | 51098.04 | 601.03 |
| | 10.96 | 6450.00 | 557367.00 | 50854.65 | 588.50 |
| | 11.01 | 6495.00 | 562407.00 | 51081.47 | 589.92 |
| | 11.01 | 6392.00 | 561937.00 | 51038.78 | 580.56 |
| | 11.15 | 6571.00 | 568687.00 | 51003.32 | 589.33 |
| | 11.71 | 6742.00 | 595751.00 | 50875.41 | 575.75 |
| | 11.92 | 6638.00 | 601847.00 | 50490.52 | 556.88 |
| | 12.07 | 6641.00 | 608029.00 | 50375.23 | 550.21 |
| AVARAGE | 11.05 | 6490.91 | 562781.45 | 50920.96 | 588.24 |
| STANDARD | 0.59 | 139.32 | 27728.02 | 247.39 | 20.72 |
| DEVIATION | | | | | |
| PERCANTAGE- | 5.36 | 2.15 | 4.93 | 0.49 | 3.52 |
| STANDARD | | | | | |
| DEVIATION | | | | | |

A method for determining (100) the number of small product in a bag package from the X-ray image, comprising;
passing the disorganized, free, and tangled products in the bag package (101) through the vibrating band (102) before x-ray scanning,
transporting the bag package (101) receiving from the vibrating band (102) to the main conveyor (105) by the input conveyor (104),
scanning the products in the bag package (101) by the x-ray scanner (106) on the main conveyor (105),
obtaining a two-dimensional image by creating numerical data according to the energy level of the rays passing through the x-ray scanner (106) by the x-ray detector (107),
receiving two-dimensional images from the x-ray sensor (107) by the control unit (109) and saving them to the computer therein,
transferring the images recorded by the control unit (109) to the image processing unit (110) via the ethernet connection (113),
determining the two-dimensional images receiving from the processor and the control unit (109) and the parts of the package containing the images of the product of interest by filtering by the image processing unit (110),
filtering the parts with a pixel value between 0 and 200 numerically by filtering by means of the image processing unit (110),
determining the product groups and their limits that are not adjacent to each other from the filtered sections by the image processing unit (110),
numerically calculating the grayness values for each group by the image processing unit (110),
calculating the total grayness value by adding the grayness value in each pixel by the image processing unit (110),
taking the moving average value of the total grayness values of each package by the image processing unit (110), and obtaining the average grayness value per product by dividing this average value by the in-pack unit value being worked at that time,
estimating how many products each group belongs to by dividing the grayness value calculated for each group by the average unit grayness value per product by the image processing unit (110),
transmitting the commands from the image processing unit (110) to the compressed air valve (111) by the input output card (112),
sorting the defective ones from the bag packages (101) moving on the output conveyor (108) that carries the bag package (101) coming out of the conveyor (105) by the compressed air valve (111) with the help of compressed air.

1. A system (100) for determining the number of small products in the bag package from the x-ray image that enables detecting the missing quantities of small products or packages in a disorganized and random position in the bag package, characterized in that, it comprises;
at least one bag package (101) containing the disorganized, free, and tangled products,
at least one vibrating band (102) that prevents the products in the bag package (101) from clumping together with vibration while the bag package (101) passes over it, thereby making them more discrete and visually distinguishable,
at least one vibration unit (103) that provides the amplitude and intensity to be adjusted by producing vibration on the vibrating band (102),
at least one inlet conveyor (104) that provides the transport of the bag package (101) receiving from the vibrating belt (102) to the main conveyor (105),
at least one main conveyor (105) that includes x-ray scanner (106), x-ray detector (107), and control unit thereon, thereby ensuring the delivery of the bag package (101) to the output conveyor (108),
at least one x-ray scanner (106) that scans the products inside the bag package (101) moving on the main conveyor (105),
At least one x-ray sensor (107) that produces a two-dimensional image by generating numerical data according to the energy level of the rays passing through the x-ray detector (106),
At least one control unit (109) that takes two-dimensional images from the x-ray sensor (107) and saves them to the computer located therein,
At least one image processing unit (110) that determines the parts of the product of interest in the package in the two-dimensional images coming from the processor and the control unit (109), by filtering, that determines the product groups and their limits that are not adjacent to each other from the filtered sections, that numerically calculates the grayness values for each group, that provides the moving average value of the total grayness values of each package, and the average per product grayness value by dividing this average value by the in-pack piece value being worked at that time, and that allows estimating how many products each group belongs to by dividing the calculated grayness value of each group by the average grayness per product unit value.
at least one output conveyor (108) that ensures transporting the bag package (101) coming out of the main conveyor (105),
at least one input and output card (112) that transmits the commands coming from the image processing unit (110) to the compressed air valve (111),
at least one compressed air valve (111) that sorts the defective ones out of the bag packages (101) moving on the output conveyor (108) with the help of compressed air.

2. A method for determining (100) the number of small products in a bag package from the X-ray image, characterized in that, it comprises the process steps of;
passing the disorganized, free, and tangled products in the bag package (101) through the vibrating band (102) before x-ray scanning,
transporting the bag package (101) receiving from the vibrating band (102) to the main conveyor (105) by the input conveyor (104),
scanning the products in the bag package (101) by the x-ray scanner (106) on the main conveyor (105),
obtaining a two-dimensional image by creating numerical data according to the energy level of the rays passing through the x-ray scanner (106) by the x-ray detector (107),
receiving two-dimensional images from the x-ray sensor (107) by the control unit (109) and saving them to the computer therein,
transferring the images recorded by the control unit (109) to the image processing unit (110) via the ethernet connection (113),
determining the two-dimensional images receiving from the processor and the control unit (109) and the parts of the package containing the images of the product of interest by filtering by the image processing unit (110),
filtering the parts with a pixel value between 0 and 200 numerically by filtering by means of the image processing unit (110),
determining the product groups and their limits that are not adjacent to each other from the filtered sections by the image processing unit (110),
numerically calculating the grayness values for each group by the image processing unit (110),
calculating the total grayness value by adding the grayness value in each pixel by the image processing unit (110),
taking the moving average value of the total grayness values of each package by the image processing unit (110), and obtaining the average grayness value per product by dividing this average value by the in-pack unit value being worked at that time,
estimating how many products each group belongs to by dividing the grayness value calculated for each group by the average unit grayness value per product by the image processing unit (110),
transmitting the commands from the image processing unit (110) to the compressed air valve (111) by the input output card (112),
sorting the defective ones from the bag packages (101) moving on the output conveyor (108) that carries the bag package (101) coming out of the conveyor (105) by the compressed air valve (111) with the help of compressed air.

3. A system (100) for determining the number of small products in the bag package from the x-ray image according to claim 1, characterized in that, it comprises a control unit (109) that enables transferring the recorded images to the image processing unit (110) via ethernet connection (113).

4. A system (100) for determining the number of small products in the bag package from the x-ray image according to claim 1, characterized in that, it comprises an image processing unit (110) that provides numerical filtering of parts with pixel values between 0 and 200 via filtering.

5. A system (100) for determining the number of small products in the bag package from the x-ray image according to claim 1, characterized in that, it comprises an image processing unit (110) that allows estimating how many products there are by dividing the total grayness numerical value of the package by the unit product grayness value.

6. A system (100) for determining the number of small products in the bag package from the x-ray image according to claim 1, characterized in that, it comprises an image processing unit (110) that limits the sorting limit values of the package over real values.
